(19) United States
(12) Patent Application Publication
(10) Pub. No.: US 2025/0103297 A1
(43) Pub. Date: Mar. 27, 2025

(54) METHOD FOR DETECTING DIGITAL PSEUDO-RANDOM SEQUENCE USING FAST LOCKING ALGORITHMS

(71) Applicant: Advanced Micro Devices, Inc., Santa Clara, CA (US)

(72) Inventors: Changhoon YEO, Santa Clara, CA (US); Tun-Fen WANG, Santa Clara, CA (US); Ajay K. DAWRA, Santa Clara, CA (US)

(21) Appl. No.: 18/372,593

(22) Filed: Sep. 25, 2023

(51) Int. Cl. G06F 7/58

(52) U.S. Cl. CPC G06F 7/582

(57) ABSTRACT

Techniques for detecting a digital pseudo-random sequence (PRS) using fast locking, including repeatedly computing a first PRS seed based on an ADC output, generating a PRS sequence based on the first seed, computing a second PRS seed based on the sequence, and comparing the sequence to the ADC output (comparison results may be provided as a bool signal), until the sequence matches the ADC output. Thereafter, the technique may include re-computing the sequence based on the second seed, re-computing the second seed based on the re-computed sequence and comparing the re-computed sequence to the ADC output. The technique may further include setting a lock when a threshold number of sequences computed from the second seed match the ADC output, and reverting to computing the sequence based on the first seed if a sequence computed from the second seed does not match the ADC output and the lock is not set.

### TECHNICAL FIELD

Examples of the present disclosure generally relate to a method for detecting digital pseudo-random binary sequence using fast locking.

### BACKGROUND

A pseudo-random binary sequence (PRBS) is mathematically randomized bit stream in which the frequency of occurrence of “1” and “0” symbols is close to 50%. PRBSs are used in telecommunications to verify link quality and transceiver operation. PRBSs are also useful in other applications. Generally, once a certain number of consecutive symbols in a PRBS sequence are known, it is possible to calculate all subsequent symbols in the testing sequence, provided that the algorithm used to generate the PRBS sequence is known. Such deterministic characteristic allows a pseudo-random binary sequence checker located at the receiving end of a data communications channel to verify the correctness of the transmitted sequence. Conventional techniques to detect a PRBS in a received signal are complex and time-consuming.

### SUMMARY

Techniques for detecting a digital pseudo-random binary sequence using fast locking are described.

One example is a method that includes computing a first digital pseudo-random sequence seed (first seed) based on an output of a de-serializer circuit, computing a digital pseudo-random sequence (sequence) based on the first seed, computing a second digital pseudo-random sequence seed (second seed) based on the sequence, and comparing the sequence to a subsequent output of the de-serializer. The method may further include re-computing the sequence based on one of the second seed and a re-computed first seed, based on a result of the comparison, to provide a first recomputed sequence, and comparing the first re-computed sequence to a current output of the de-serializer circuit.

Another example described herein is an integrated circuit (IC) device that includes a dynamic pseudo-random sequence seed generator circuit (dynamic seed generator) that computes a first digital pseudo-random sequence seed (first seed) based on an output of a de-serializer circuit, an optimized pseudo-random sequence generator circuit (optimized sequence generator) that computes a digital pseudo-random sequence (sequence) based on the first seed and compute a second digital pseudo-random seed (second seed) based on the sequence, and a pseudo-random sequence checker circuit (checker) that computes compares the sequence to a subsequent output of the de-serializer circuit and outputs results of the comparison as a bool signal.

The IC device may further include control circuitry that initializes a seed select control to a first state corresponding to the first seed, retains the seed select control at the first state if the sequence does not match the subsequent output of the de-serializer circuit, and sets the seed select control to a second state corresponding to the second seed if the sequence matches the subsequent output of the de-serializer circuit.

The optimized sequence generator may re-compute the sequence based on a selectable one of a re-computed first seed and the second seed, based on the seed select control, to provide a first re-computed sequence, and the checker may compare the first re-computed sequence to a current output of the de-serializer circuit.

Another example described herein is an IC device that includes a digital pseudo-random sequence detector circuit that converts a de-serialized segment of a digital stream to a first digital pseudo-random sequence seed (first seed), and detects a digital pseudo-random sequence of the digital stream based on the first seed. The digital pseudo-random sequence detector circuit may convert the de-serialized segment to the first seed by arranging the de-serialized segment of the digital stream based on a bit position of a first bit or a first symbol of the segment of the digital stream.

In an embodiment, the digital pseudo-random sequence detector circuit computes a digital pseudo-random sequence (sequence) based on the first seed, computes a second digital pseudo-random sequence seed (second seed) based on the sequence, and compares the sequence to a subsequent de-serialized segment of the digital stream. The digital pseudo-random sequence detector circuit may further, re-compute the first seed based on a subsequent de-serialized segment of the digital stream, re-compute the sequence based on the re-computed first seed to provide a first re-computed sequence if the sequence does not match the subsequent de-serialized segment of the digital stream, re-compute the sequence based on the second seed to provide the first re-computed sequence if the sequence matches the subsequent de-serialized segment of the digital stream, and compare the first re-computed sequence to a current de-serialized segment of the digital stream.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of an adaptive digital pseudo-random sequence detector circuit (adaptive detector) that dynamically computes an adaptive pseudo-random sequence seed (adaptive seed) based on de-serialized data of a data stream, and detects a digital pseudo-random sequence of the data stream based on the adaptive seed, according to an embodiment.

FIG. 2 is a block diagram of a receiver that includes the adaptive detector, according to an embodiment.

FIG. 3 is another block diagram of the adaptive detector, according to an embodiment.

FIG. 4 is a block diagram of control circuitry of the adaptive detector, according to an embodiment.

FIG. 5 is a block diagram of a digital pseudo-random sequence generator of the adaptive detector, according to an embodiment.

FIG. 6 is another block diagram of the digital pseudo-random sequence generator, according to an embodiment.

FIG. 7A is a flowchart of a method of detecting a digital pseudo-random sequence, according to an embodiment.

FIG. 7B is a flowchart of the method of FIG. 7A, further including quality control functions, according to an embodiment.

FIG. 8 is another block diagram of the adaptive detector, according to an embodiment.

FIG. 9 is a flowchart of a method of computing an adaptive digital pseudo-random sequence seed based on de-serialized data, according to an embodiment.

FIG. 10 is a flowchart of a method of computing a digital pseudo-random sequence based a digital pseudo-random sequence seed computed from de-serialized data or based on a second seed computed from another digital pseudo-random sequence, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe techniques for detecting a digital pseudo-random sequence using fast locking are described.

A digital pseudo-random sequence may include binary bits that have one of two states (0,1), or non-binary bits/symbols that have one of i states, where i>2. Where i=3 (i.e., each bit/symbol has one of three states), the bits/symbols may be referred to as ternary bits/symbols, or trits. A sequence having binary bits may be referred to herein as a digital pseudo-random binary sequence (PRBS). A sequence having non-binary bits/symbols may be referred to herein as a digital pseudo-random trit sequence (PRTS).

Traditionally, a transmitter and a receiver are provided with an identical PRBS seed. The transmitter generates a PRBS based on the seed, converts the PRBS to an analog signal, and transmits the analog signal over a channel. The receiver includes an analog-to-digital converter (ADC) that converts the analog data stream to digital bit stream, a de-serializer that de-serializes segments of the digital bit stream, a PRBS generator computes the PRBS locally based on the seed, and a PRBS comparator that compares the locally-generated PRBS to the de-serialized segments of the digital bit stream. When a match is found, the receiver may lock-in receiver parameters (e.g., timing, phase, and/or frequency parameters).

The received analog signal may be time-shifted relative to the transmitted analog signal, and/or the PRBS generator in the receiver may start at a different time than a PRBS generator in the transmitter. Either of the foregoing situations impact the ability (i.e., increase the time needed) of the receiver to match the PRBS to a de-serialized segment of the digital bit stream. To compensate for time-shift and/or start-time differences, the PRBS comparator may analyze multiple (e.g., all possible) time-shifted versions of the de-serializer output, at every output cycle of the de-serializer. The foregoing approach substantially increases complexity of the PRBS comparator and takes considerable time to find a match.

The length of a PRBS also impacts locking time, which can be represented as:

Maximum PRBS locking time=(2num of PRBS Seed−1)/ADC output sample (binary) number*ADC output clock (time); and

Maximum PRTS locking time=(3num of PRBS Seed−1)/ADC output sample (trit) number*ADC output clock (time).

As an example, for a PRTS having 19 bits/symbols (PRTS19), the maximum locking time can be calculated as:

Maximum PRTS19 locking time (100 Mhz, 32 trits)=(319−1)/32*10 ns=363.2 (ms)

The foregoing equations assume there are no bit/symbol errors in the de-serializer output. If there are bit/symbol errors on the de-serializer output in a given cycle, no match will be detected during the cycle, which will increase the locking time.

Techniques are disclosed herein for detecting a digital pseudo-random sequence/pattern with fast locking.

In an embodiment, the technique includes generating an adaptive pseudo-random sequence seed (first seed) based on an ADC output, generating a pseudo-random sequence (sequence) based on the first seed, comparing the sequence to a subsequent ADC output, and outputting results of the comparison as a bool (true/false) signal.

The technique may further include generating a second seed based on the first sequence, generating a second sequence based on the second seed in response to the bool signal, and comparing the second sequence to a subsequent output of the ADC. If the second sequence matches the subsequent output of the ADC, the second seed may be re-computed from the second sequence, and the second sequence may be re-computed based on the re-computed second seed. If the second sequence does not match the subsequent output of the ADC, processing may revert to re-computing the first seed and the first sequence.

Techniques disclosed herein may be performed without providing identical seeds to transmitters and receivers.

Techniques disclosed herein are independent of PRBS length, which may significantly reduce detection/locking time. Techniques disclosed herein may synchronize or lock within as few as two cycles. A minimum threshold number of cycles may be user-configurable for increased detection reliability. For example, if there are two successive ADC outputs without error, locking time can be calculated as (for a 100 MHz clock rate):

Pseudo-Random Sequence locking time (100 Mhz, any Pseudo-Random Sequence)=2*10 ns=20 (ns)

Techniques disclosed herein do not require examination of time-shifted versions of the ADC output, which significantly reduces logic requirements, in additional to locking time, which provides significant area/power savings.

Techniques disclosed herein may be readily implemented in existing digital receiver designs/applications with relatively minimal re-design effort. Techniques disclosed herein may, for example, be readily implemented in serializer/de-serializer (SERDES) applications, including, without limitation, a mobile industry processor interface (MIPI), a universal serial bus (USB) interface, a peripheral component interface express (PCIE) interface, and other SERDES interfaces that utilize pseudo-random sequence detection.

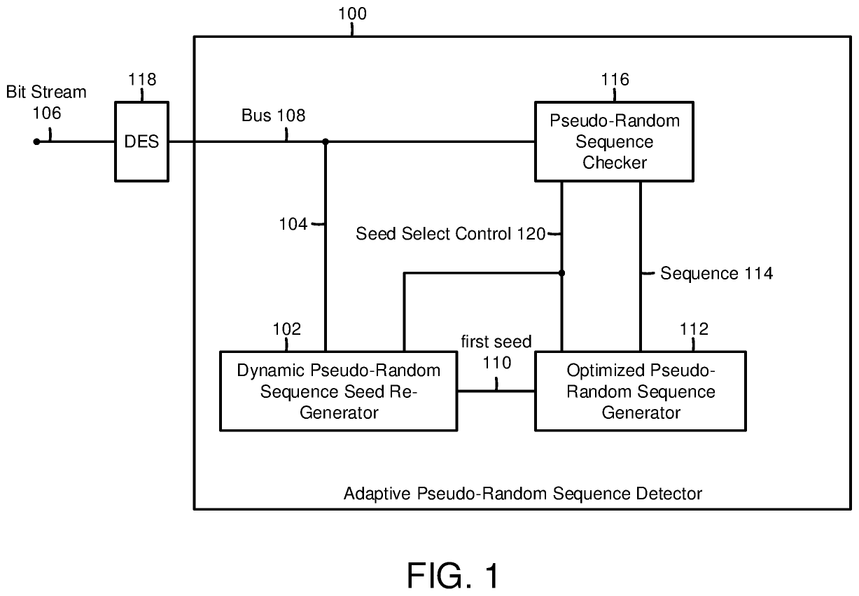

FIG. 1 is a block diagram of an adaptive digital pseudo-random sequence detector circuit (adaptive detector) 100 that dynamically computes an adaptive pseudo-random sequence seed (adaptive seed) based on de-serialized data of a data stream and detects a digital pseudo-random sequence of the data stream based on the adaptive seed, according to an embodiment.

Adaptive detector 100 may be implemented in circuitry (e.g., as part of an integrated circuit device), which may include configurable/programmable circuitry, such as application-specific integrated circuit (ASIC) device and/or a field-programmable gate array (FPGA).

In the example of FIG. 1, adaptive detector 100 includes a dynamic digital pseudo-random sequence seed re-generator (dynamic seed re-generator) 102 that periodically computes, or re-computes an adaptive digital pseudo-random seed (first seed) 110 based on de-serialized data 104. A de-serializer circuit 118 may periodically de-serialize segments of a digital stream 106 and output the de-serialized segments to a bus 108 as de-serialized data 104.

Adaptive detector 100 further includes an optimized digital pseudo-random sequence generator (optimized sequence generator) 112 that computes a digital pseudo-random sequence (sequence) 114 based (directly or indirectly) on first seed 110. Adaptive detector 100 further includes a digital pseudo-random sequence checker (checker) 116 that compares sequence 114 to subsequent de-serialized data 104 on bus 108.

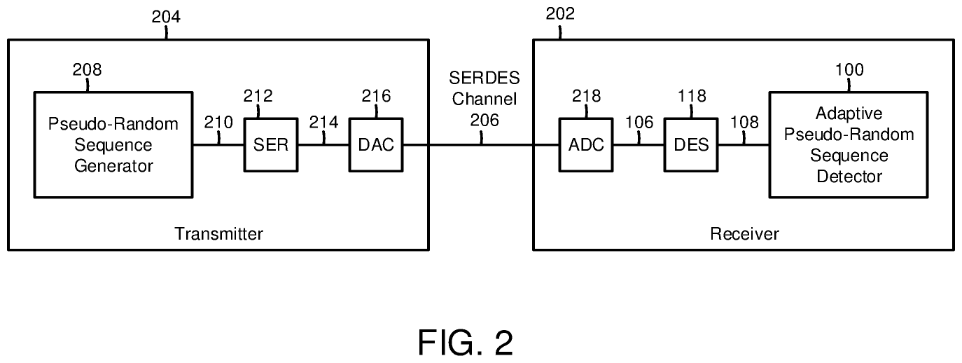

Adaptive detector 100 may be part of a receiver, such as described below with reference to FIG. 2. FIG. 2 is a block diagram of a receiver 202 that includes adaptive detector 100, according to an embodiment. Receiver 202 may represent a serializer/de-serializer (SERDES) receiver that receives a signal from a transmitter 204 over a SERDES channel 206.

In the example of FIG. 2, transmitter 204 includes a digital pseudo-random sequence generator 208 that generates a digital pseudo-random sequence (sequence) 210, a serializer 212 that serializes sequence 210 to provide a serialized data stream 214, and a digital-to-analog converter (DAC) 216 that converts serialized data stream 214 to an analog signal for transmission over SERDES channel 206.

Receiver 202 further includes an analog-to-digital converter (ADC) 218 that converts the analog signal to digital stream 106, and de-serializer circuit 118 that periodically outputs de-serialized segments of digital stream 106 to bus 108. ADC 218 and de-serializer circuit 118 may represent a SERDES physical layer circuit (SERDES PHY).

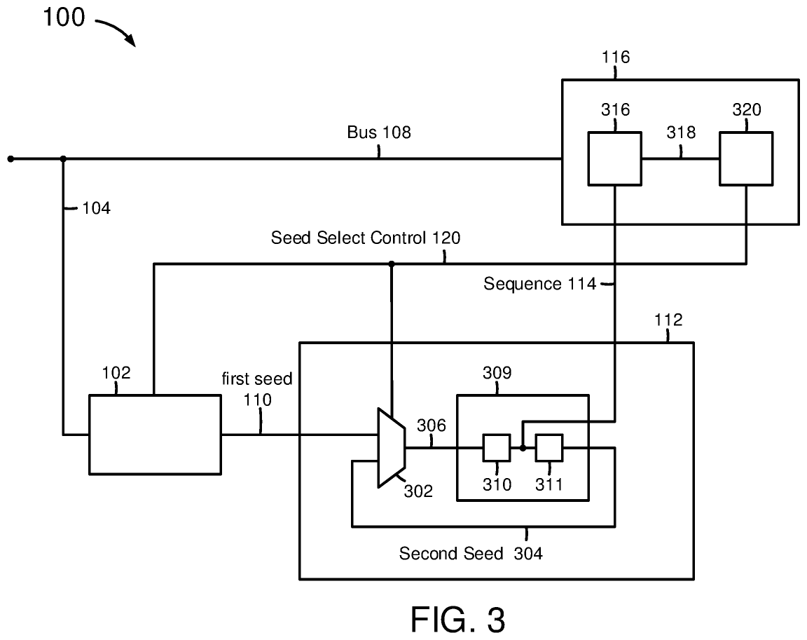

FIG. 3 is another block diagram of adaptive detector 100, according to an embodiment. In the example of FIG. 3, optimized sequence generator 112 includes selection circuitry, illustrated here as a multiplexer 302, that selects first seed 110 or a second seed 304 as a current seed 306, based on a seed select control 120. Optimized sequence generator 112 further includes circuitry 309 that includes a digital pseudo-random sequence generator (sequence generator) 310 that computes sequence 114 based on current seed 306. Circuitry 309 further includes a digital pseudo-random sequence seed generator circuit (second seed generator) 311 that computes second seed 304 based on sequence 114.

Further in the example of FIG. 3, checker 116 includes error detection circuitry 316 that compares sequence 114 to de-serialized data on bus 108, and outputs corresponding comparison results 318. Error detection circuitry 316 may provide results 318 as a bool (i.e., a true/false) signal indicative of whether sequence 114 matches de-serialized data on bus 108.

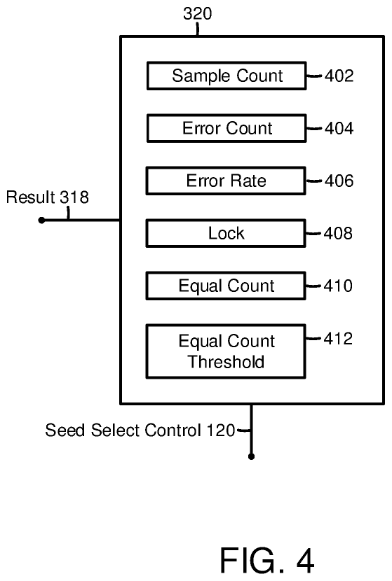

Checker 116 further includes control circuitry 320 that controls seed select control 120 based on results 318. Control circuitry 320 may provide one or more controls based on the evaluation. Control circuitry 320 may maintain and/or compute one or more parameters based on results 318, examples of which are provided below with reference to FIG. 4. FIG. 4 is a block diagram of control circuitry 320, according to an embodiment. In the example of FIG. 4, control circuitry 320 maintains a sample count 402, an error count 404, an error rate 406, a lock 408, an equal count 410, and an equal count threshold 412, which are described further below.

A circuit designer and/or an electronic design automation (EDA) tool may readily modify an existing circuit design to replace a legacy pseudo-random sequence detector with adaptive detector 100. For example, a legacy pseudo-random sequence detector static seed component may be replaced with dynamic seed re-generator 102. This change does not increase logic count since first seed 110 is computed based on digital stream 106 output by ADC 218. A legacy pseudo-random sequence generator may be replaced with optimized sequence generator 112. This change does not increase logic count because the primary algorithms employed may be substantially similar or identical. A legacy pseudo-random sequence comparator may be replaced with checker 116. This change may significantly reduce logic count since checker 116 performs a simple comparison and generates a bool result, rather than performing complex time-shift searching operations described further above. Thus, traditional time-shift searching logic may be omitted. Checker 116 may also reduce locking time and may reduce total SERDES high-speed data transaction and receiving period for locking-up.

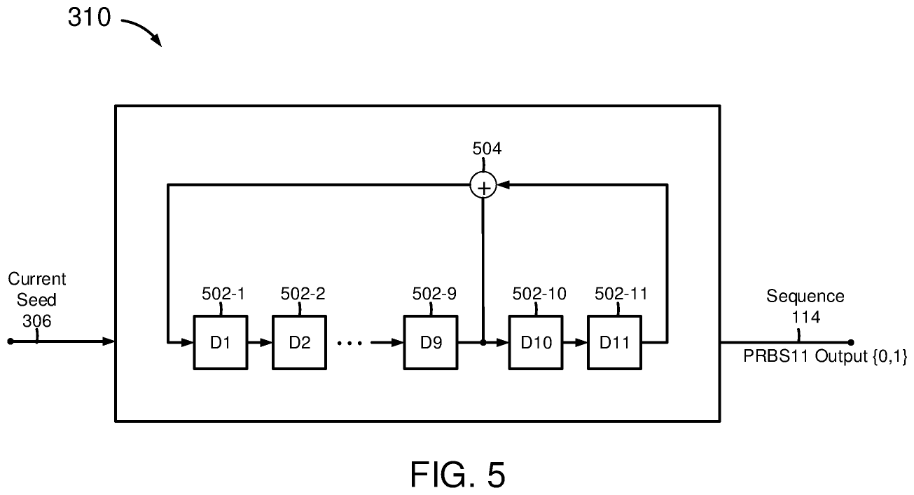

FIG. 5 is a block diagram of sequence generator 310, according to an embodiment. In the example of FIG. 5, sequence generator 310 includes 11 cells (e.g., flip-flops) 502-1 through 502-11, that are loaded with respective bits D1 through D11 of an 11-bit current seed 306. Each clock cycle, sequence generator 310 right-shifts bits D1 through D11, and outputs the current contents of cells 502-1 through 502-11 as sequence 114. PRBS11 output will be asserted on D1. Sequence generator 310 further includes a binary summer 504, which may be implemented with OR logic. The example of FIG. 5 may be referred to as a PRBS11 embodiment.

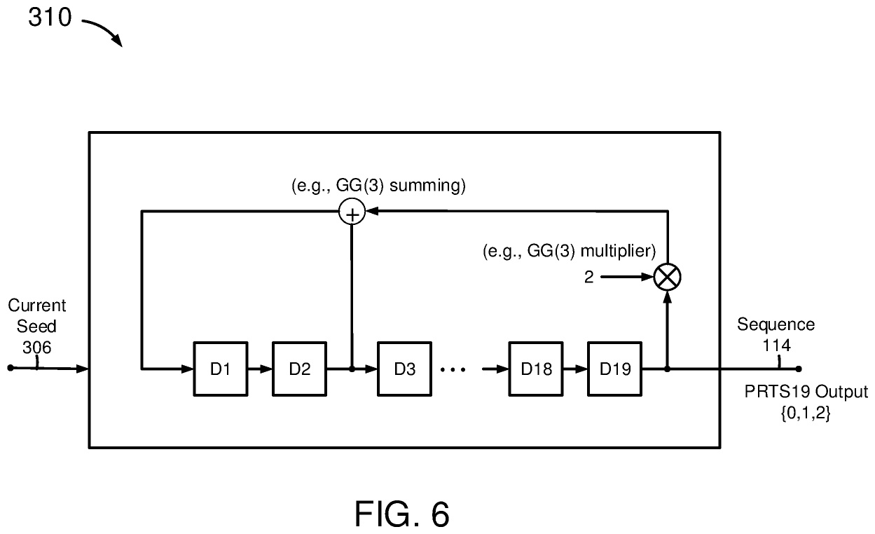

FIG. 6 is another block diagram of sequence generator 310, according to an embodiment. In the example of FIG. 6, sequence generator 310 includes 19 cells 602-1 through 602-19 that are loaded with respective ternary bits (i.e., trits) D1 through D19, of a 19-trit current seed 306. Each clock cycle, sequence generator 310 right-shifts trits D1 through D19, and outputs contents of cells 602-1 through 602-19 as sequence 114. The example of FIG. 6 may be referred to as a PRTS19 embodiment.

In FIG. 6, sequence generator 310 includes a summer 604 and a multiplier 606. Summer 604 may perform a GF(3) summing operation in accordance with Table 1. Multiplier 605 may perform a GF(3) multiplication operation in accordance with Table 2.

TABLE 1

| + | 0 | 1 | 2 |
|---|---|---|---|
| 0 | 0 | 1 | 2 |
| 1 | 1 | 2 | 0 |
| 2 | 2 | 0 | 1 |

TABLE 2

| x | 0 | 1 | 2 |
|---|---|---|---|
| 0 | 0 | 0 | 0 |
| 1 | 0 | 1 | 2 |
| 2 | 0 | 2 | 1 |

Sequence generator 310 is not limited to the examples of FIGS. 5 and 6.

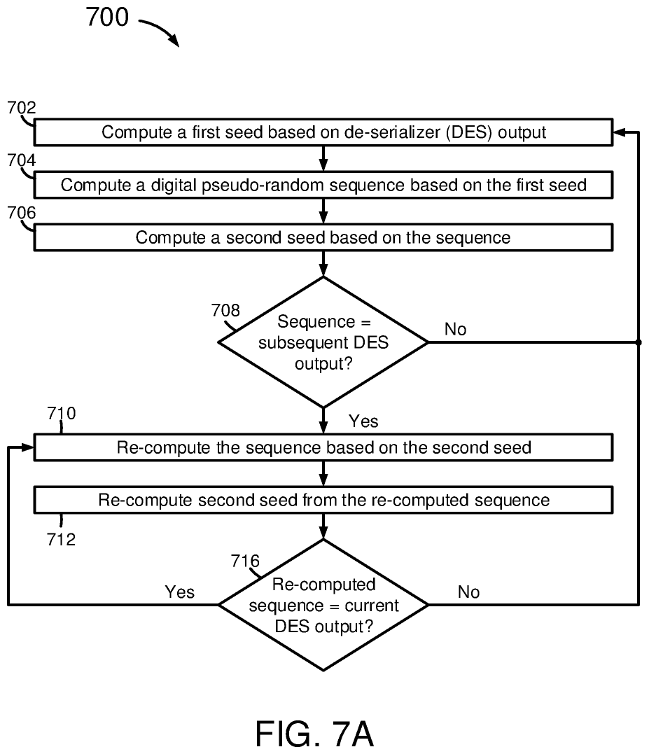

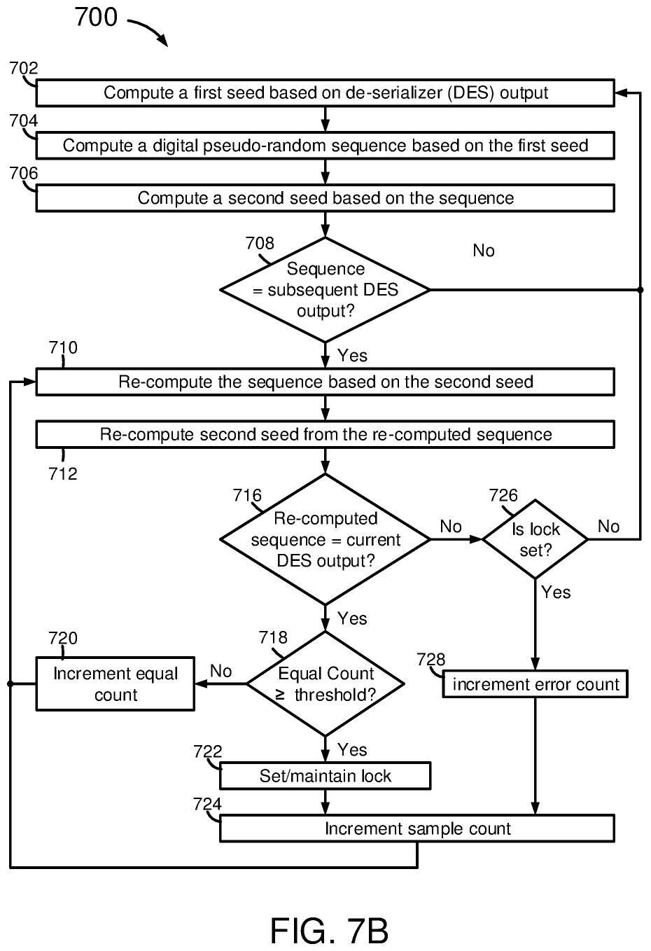

Adaptive detector 100 is described below with reference to FIGS. 7A and 7B. FIG. 7A is a flowchart of a method 700 of detecting a digital pseudo-random sequence, according to an embodiment. FIG. 7B is a flowchart of method 700, further including quality control functions, according to an embodiment. Method 700 is described below with reference to adaptive detector 100. Method 700 is not, however, limited to adaptive detector 100.

At 702, dynamic seed re-generator 102 computes first seed 110 based on de-serialized data 104. Dynamic seed re-generator 102 may periodically compute first seed 110 based on respective periodic outputs of de-serializer circuit 118 (i.e., based on subsequent states of bus 108). In an embodiment, dynamic seed re-generator 102 periodically compute first seed 110 if seed select control 120 is at a first state, and halts compute first seed 110 if seed select control 120 is at a second state. Example techniques to compute first seed 110 based on de-serialized data 104 are provided further below.

At 704, optimized sequence generator 112 computes a sequence 114 based on first seed 110. In FIG. 3, control circuitry 320 may initialize seed select control 120 to the first state, such that multiplexer 302 selects first seed 110 as current seed 306, and sequence generator 310 computes sequence 114 based on first seed 110.

At 706, second seed generator 312 computes second seed 304 based on sequence 114. Optimized sequence generator 112 may temporarily hold or store second seed 304. Example techniques to compute second seed 304 based on sequence 114 are provided further below.

At 708, error detection circuitry 316 compares sequence 114 to de-serialized data on bus 108 and outputs result 318 of the comparison. Error detection circuitry may output result 318 as a bool signal (i.e., a digital true/false signal).

In an embodiment, dynamic seed re-generator 102 computes first seed 110 (at 702) based on de-serialized data 104 output from de-serializer circuit 118 in a first cycle, and error detection circuitry 316 compares sequence 114 to de-serialized data output from de-serializer circuit 118 in a subsequent cycle (at 708). In an embodiment, 702 through 706 are performed for each output cycle of de-serializer circuit 118, and item 708 is performed on respective subsequent output cycles of de-serializer circuit 118, until an instance of sequence 114 matches de-serialized data on bus 108.

If sequence 114 does not match the de-serialized data on bus 108, processing returns to 702, where dynamic seed re-generator re-computes first seed 110 based on current de-serialized data 104, and proceeds to 704 where optimized sequence generator 112 re-computes sequence 114 based on the re-computed first seed 110.

When a sequence 114 computed from a first seed 110 matches de-serialized data on bus 108, processing proceeds to 710, where control circuitry 320 sets seed select control 120 to the second state, such that multiplexer 302 selects second seed 304 as current seed 306, and sequence generator 310 re-computes sequence 114 based on second seed 304.

At 712, second seed generator 312 re-computes second seed 304 based on current sequence 114, for later use.

At 714, error detection circuitry 316 compares the re-computed sequence 114 to current de-serialized data on bus 108. If the re-computed sequence 114 matches the current de-serialized data on bus 108, processing returns to 710. In FIG. 3, control circuitry 320 maintains seed select control 120 at the second state such that 710 and 712 are repeated. If the re-computed sequence 114 does not match the current de-serialized data on bus 108, processing returns to 702.

Control circuitry 320 may perform one or more functions (e.g., quality control functions) based on results 318, such as described below with reference to FIG. 7B.

In FIG. 7B, if the re-computed sequence 114 matches the current de-serialized data on bus 108, processing proceeds to 718, where control circuitry 320 compares equal count 410 to equal count threshold 412. Equal count 410 indicates a number preceding sequences 114, generated from respective instances of second seed 304, that matched de-serialized data on bus 108. As described further below, equal count threshold 412 and lock 408 provide a mechanism to permit control circuitry 320 to revert to computing sequence 114 based on first seed 110 (e.g., in the event of a misdetection at 708).

If equal count 332 does not meet equal count threshold 412, processing proceeds to 720, where control circuitry 320 increments equal count 410. Processing then returns to 710, where sequence generator 310 computes another sequence 114 based on second seed 304, previously computed at 712

If equal count 332 meets equal count threshold 412, processing proceeds to 722, where control circuitry 320 sets lock 408, if lock 408 is not already set. Lock 408 is thus set when a threshold number (i.e., equal count threshold 412) of sequences 114 computed from respective second seeds 304, match de-serialized data on bus 108.

At 724, control circuitry 320 increments sample count 402, and processing returns to 710, where sequence generator 310 computes another sequence 114 based on second seed 304, previously computed at 712.

Returning to 716, if the sequence 114 computed at 710 does not match the de-serialized data on bus 108, processing proceeds to 726. There are several situations where the sequence 114 computed at 710 may not match the de-serialized data on bus 108.

In a first situation, 710, 712, and 716 are performed for a first-time following item 708. In this situation, if there was a bit error in the de-serialized data on bus 108 at 702, the sequence 114 computed at 704 may mistakenly match the subsequent de-serialized data on bus 108 at 708. In such a scenario, it is unlikely that the sequence 114 computed at 710, based on the second seed 304 computed at 706, will match the de-serialized data on bus 108 at 716.

In a second situation, if there is a bit error in the de-serialized data on bus 108 at 716, the sequence 114 computed at 710 (in a first iteration or a subsequent iteration of 710 through 712) may not match the de-serialized data on bus 108 at 716.

At 726, control circuitry 320 checks lock 408. If lock 408 is not set (i.e., in an unlocked state), processing returns to 702, where optimized sequence generator 112 re-computes sequence 114 based on a current state of first seed 110. In FIG. 3, control circuitry 320 reverts seed select control 120 to the first state, such that multiplexer 302 selects a current state of first seed 110 as current seed 306. Equal count threshold 412 and lock 408 provide a mechanism to permit control circuitry 320 to revert to computing sequence 114 based on first seed 110 (e.g., in the event of a misdetection at 708). Equal count threshold 412 may be configurable to control detection reliability.

If lock 408 is set (i.e., in a locked state), processing proceeds to 728, where control circuitry 320 increments error count 326. Thus, after a threshold number of sequences 114, computed from respective second seeds 304 at 712, match de-serialized data on bus 108 at 714, sequence generator 310 continues computing sequences 114 based on respective instances of second seed 304, and control circuitry 320 interprets any mismatch at 714 as a data error in the de-serialized data on bus 108.

Processing then proceeds to 724, where control circuitry 320 increments sample count 402. Processing then returns to 710, where sequence generator 310 computes another sequence 114 based on a current state of second seed 304 (i.e., re-computed at 712).

In the example of FIG. 7B, once lock 408 is set at 722, sequence generator 310 computes subsequent sequences 114 based on respective instances of second seed 304. In an embodiment, control circuitry 320 may reset seed select control 120 and lock 408 in certain situations, such that optimized sequence generator 112 reverts to computing sequence 114 based on first seed 110. For example, and without limitation, control circuitry 320 may compute error rate 406 based on sample count 402 and error count 404 and may reset seed select control 120 and lock 408 if error rate 328 exceeds an error rate threshold. As another example, control circuitry 320 may reset seed select control 120 and lock 408 based on user input and/or other factor(s).

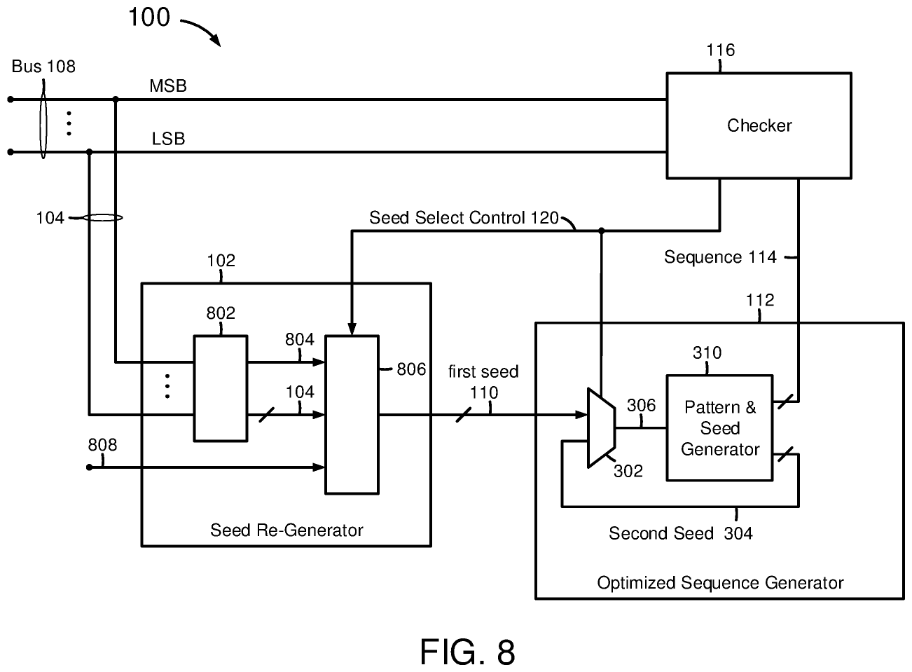

FIG. 8 is another block diagram of adaptive detector 100, according to an embodiment. In the example of FIG. 8, dynamic seed re-generator 102 includes a data format detector circuit 802 that determines formatting parameters 804 of de-serialized data 104. Dynamic seed re-generator 102 further includes seed mapping circuitry 806 that maps de-serialized data 104 to first seed 110 based on formatting parameters 804 and/or other parameters 808, such as seed size and data format parameters for first seed 110. Seed regenerator may compute first seed 110 as a copy of de-serialized data, formatted based on parameters 804 and/or parameters 808. Second seed generator 311 may compute second seed 304 from sequence 114 in a similar fashion. A bit-width of sequence 114 may be the same as a bit-width of de-serialized data 104 (i.e., a bit-width of the output of de-serializer circuit 118).

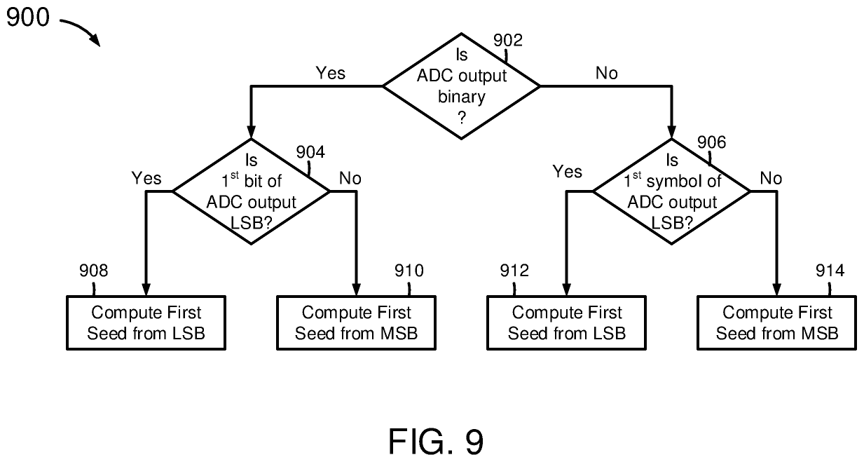

Adaptive detector 100, as illustrated in FIG. 8 is described below with reference to FIG. 9. FIG. 9 is a flowchart of a method 900 of computing a digital adaptive pseudo-random sequence seed (e.g., first seed 110) based on de-serialized data, according to an embodiment. Method 900 is described below with reference to seed mapping circuitry 806 in FIG. 8. Method 900 is not, however, limited to the example of FIG. 8.

At 902, if de-serialized data 104 is binary (i.e., each bit is one of two states), processing proceeds to 904. If de-serialized data 104 is non-binary (e.g., multi-level, ternary, or other non-binary data), processing proceeds to 906,

At 904, if the first bit of the output of ADC 218 (i.e., digital stream 106) is the least significant bit (LSB), processing proceeds to 908, where seed mapping circuitry 806 computes first seed 110 from the LSB. Seed mapping circuitry 806 may map de-serialized data 104 to first seed 110 such that the LSB of bus 108 corresponds to the LSB of first seed 110. Seed mapping circuitry 806 may compute first seed 110 as: PRBS[x] Seed Set={ADC Binary output[n−1], ADC Binary output[n−2], ADC Binary output[n−3] . . . , ADC Binary output[n−x]}, where ADC Binary Output[n−1] through ADC Binary Output[n−x] represent respective bits of bus 108.

If, at 904, the first bit of the output of ADC 218 is the most significant bit (MSB), processing proceeds to 910, where seed mapping circuitry 806 computes first seed 110 from the MSB. Seed mapping circuitry 806 may map de-serialized data 104 to first seed 110 such that the MSB of bus 108 corresponds to the MSB of first seed 110. Seed mapping circuitry 806 may compute first seed 110 as: PRBS[x] Seed Set={ADC Binary output[0], ADC Binary output[1], ADC Binary output[2] . . . , ADC Binary output[x−1]}, where ADC Binary Output [0] through ADC Binary Output [x−1] represent respective bits of bus 108.

At 906, if the first symbol of the output of ADC 218 is the LSB, processing proceeds to 912, where seed mapping circuitry 806 computes first seed 110 from the LSB. Seed mapping circuitry 806 may map de-serialized data 104 to first seed 110 such that the LSB of bus 108 corresponds to the LSB of first seed 110. Seed mapping circuitry 806 may compute first seed 110 as: PRTS Seed Set={ADC non-binary output[n−1], ADC non-binary output[n−2], ADC non-binary output[n−3] . . . . ADC non-binary output[n−x]}, where ADC non-binary output[n−1] through ADC non-binary output[n−x] represent respective bits/symbols of de-serialized data 104.

If, at 906, the first symbol of the output of ADC 218 is the MSB, processing proceeds to 914, where seed mapping circuitry 806 computes first seed 110 from the MSB. Seed mapping circuitry 806 may map de-serialized data 104 to first seed 110 such that the MSB of bus 108 corresponds to the MSB of first seed 110. Seed mapping circuitry 806 may compute first seed 110 as: PRTS Seed Set=(ADC non-binary output[0], ADC non-binary output[1], ADC non-binary output[2] . . . , ADC non-binary output[x−1]), where ADC non-binary output[0] through ADC non-binary output[x−1] represent bits of bus 108.

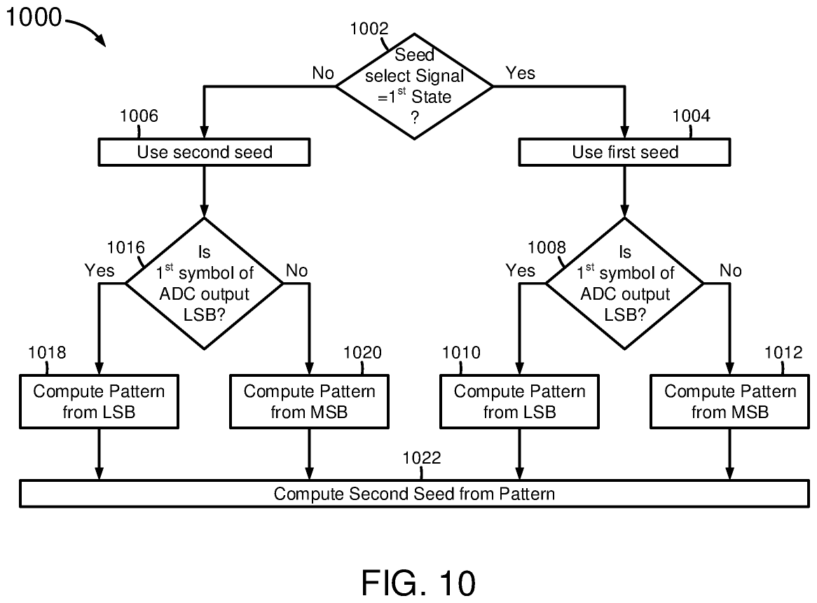

FIG. 10 is a flowchart of a method 1000 of computing a digital pseudo-random sequence (e.g., sequence 114) based a first seed computed from de-serialized data or based on a second seed computed from another digital pseudo-random sequence, according to an embodiment. Method 1000 is described below with reference to optimized sequence generator 112. Method 1000 is not, however, limited to the optimized sequence generator 112.

At 1002, if seed select control 120 is at the first state, processing proceeds to 1004, where multiplexer 302 selects first seed 110 as current seed 306. From 1004, processing proceeds to 1008. At 1008, if the first symbol of the output of ADC 218 is the LSB, processing proceeds to 1010, where sequence generator 310 computes sequence 114 from the LSB of first seed 110. Where first seed 110 is binary, sequence generator 310 may compute sequence 114 as: PRBS[x] Data output={PRBS Binary output[x+n−1] . . . , PRBS Binary output[x+2], PRBS Binary output[x+1], PRBS Binary output[x]}. Where first seed 110 is non-binary, sequence generator 310 may compute sequence 114 as: Corresponding Pseudo-Random Sequence Data output={Symbol output[x+n−1], . . . . Symbol output[x+2], Symbol output[x+1], Symbol output[x]}.

At 1022, second seed generator 311 re-computes second seed 304 based on sequence 114 computed at 1010, such as described further above with reference to 706 in FIG. 7A.

If, at 1008, the first symbol of the output of ADC 218 is the MSB, processing proceeds to 1012, where sequence generator 310 computes sequence 114 from the MSB of first seed 110. Where first seed 110 is binary, sequence generator 310 may compute sequence 114 as: PRBS[x] Data output={PRBS Binary output[x], PRBS Binary output[x+1], PRBS Binary output[x+2] . . . . PRBS Binary output[x+n−1]}. Where first seed 110 is non-binary, sequence generator 310 may compute sequence 114 as: Corresponding Pseudo-Random Sequence Data output={Symbol output[x] . . . , Symbol output[x+1], Symbol output[x+n−2], Symbol output[x+n−1]}.

At 1022, sequence generator 310 re-computes second seed 304 based on sequence 114 computed at 1012, such as described further above with reference to 706 in FIG. 7A.

Returning to 1002, if seed select control 120 is at the second state, processing proceeds to 1006, where multiplexer 302 selects second seed 304 as current seed 306. From 1006, processing proceeds to 1016. At 1016, if the first symbol of the output of ADC 218 is the LSB, processing proceeds to 1018, where sequence generator 310 computes sequence 114 from the LSB of second seed 304. Where second seed 304 is binary, sequence generator 310 may compute sequence 114 as: PRBS[x] Data output=(PRBS Binary output[n−1], . . . , PRBS Binary output[2], PRBS Binary output[1], PRBS Binary output[0]. Where second seed 304 is non-binary, sequence generator 310 may compute sequence 114 as: Corresponded Pseudo-Random Sequence Data output={Symbol output[n−1], . . . , Symbol output[2], Symbol output[1], Symbol output[0]}.

At 1022, sequence generator 310 re-computes second seed 304 based on sequence 114 computed at 1018, such as described further above with reference to 712 in FIG. 7A.

If, at 1016, the first symbol of the output of ADC 218 is the MSB, processing proceeds to 1020, where sequence generator 310 computes sequence 114 from the MSB of second seed 304. Where second seed 304 is binary, sequence generator 310 may compute sequence 114 as: PRBS[x] Data output={PRBS Binary output[0], . . . , PRBS Binary output[n−3], PRBS Binary output[n−2], PRBS Binary output[n−1]}. Where second seed 304 is non-binary, sequence generator 310 may compute sequence 114 as: Corresponded Pseudo-Random Sequence Data output={Symbol output[0], . . . , Symbol output[n−3], Symbol output[n−2], Symbol output[n−1]}.

At 1022, sequence generator 310 re-computes second seed 304 based on sequence 114 computed at 1022, such as described further above with reference to 712 in FIG. 7A.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product.

Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method, comprising:
computing a first digital pseudo-random sequence seed (first seed) based on an output of a de-serializer circuit;
computing a first digital pseudo-random sequence (first sequence) based on the first seed;
computing a second digital pseudo-random sequence seed (second seed) based on the first sequence; and
comparing the first sequence to a subsequent output of the de-serializer circuit.

2. The method of claim 1, further comprising:
re-computing the first seed based on the subsequent output of the de-serializer circuit;
selecting one of the second seed and the re-computed first seed as a current seed based on a result of the comparing;
computing a second digital pseudo-random sequence (second sequence) based on the current seed; and
comparing the second sequence to a current output of the de-serializer circuit.

3. The method of claim 2, wherein the selecting one of the second seed and the re-computed first seed further comprises:
selecting the re-computed first seed if the first sequence does not match the subsequent output of the de-serializer; and
selecting the second seed if the first sequence matches the subsequent output of the de-serializer.

4. The method of claim 3, wherein the selecting one of the second seed and the re-computed first seed further comprises selecting the second seed, the method further comprising:
re-computing the second seed based on the second sequence.

5. The method of claim 4, further comprising:
incrementing an equal count and computing a third digital pseudo-random sequence based on the re-computed second seed if the second sequence matches the current output of the de-serializer and the equal count does not meet an equal count threshold.

6. The method of claim 4, further comprising:
setting a lock, incrementing a sample count, and computing a third digital pseudo-random sequence based on the re-computed second seed, if the second sequence matches the current output of the de-serializer and the equal count meets the equal count threshold.

7. The method of claim 4, further comprising:
incrementing an error count, incrementing a sample count, and computing a third digital pseudo-random sequence based on the re-computed second seed, if the second sequence does not match the current output of the de-serializer and a lock is set.

8. The method of claim 4, further comprising:
re-computing the first seed based on the subsequent output of the de-serializer; and
computing a third digital pseudo-random sequence based on the re-computed first seed if the second sequence does not match the current output of the de-serializer and a lock is not set.

9. The method of claim 4, further comprising:
incrementing an equal count and computing a third digital pseudo-random sequence based on the re-computed second seed if the second sequence matches the current output of the de-serializer and the equal count does not meet an equal count threshold;
setting a lock, incrementing a sample count, and computing the third digital pseudo-random sequence based on the re-computed second seed, if the second sequence matches the current output of the de-serializer and the equal count meets the equal count threshold;
incrementing an error count, incrementing the sample count, and computing the third pseudo-random sequence based on the re-computed second seed, if the second sequence does not match the current output of the de-serializer and the lock is set;
re-computing the first seed based on the subsequent output of the de-serializer; and
computing the third pseudo-random sequence based on the re-computed first seed if the second sequence does not match the current output of the de-serializer and the lock is not set.

10. The method of claim 1, wherein:
the de-serializer circuit is configured to de-serialize a segment of a digital stream; and
the computing a first seed comprises arranging the output of the de-serializer based on a bit position of a first bit or a first symbol of the segment of the digital stream.

11. An integrated circuit (IC) device, comprising:
a dynamic pseudo-random sequence seed generator circuit (dynamic seed generator) configured to compute a first digital pseudo-random sequence seed (first seed) based on an output of a de-serializer circuit;
an optimized pseudo-random sequence generator circuit (optimized sequence generator) configured to compute a first digital pseudo-random sequence (first sequence) based on the first seed and to compute a second digital pseudo-random seed (second seed) based on the first sequence; and
a pseudo-random sequence checker circuit (checker) configured to compare the first sequence to a subsequent output of the de-serializer circuit and to output results of the comparison as a bool signal.

12. The IC device of claim 11, further comprising control circuitry configured to:
initialize a seed select control to a first state corresponding to the first seed;
retain the seed select control at the first state if the first sequence does not match the subsequent output of the de-serializer circuit; and
set the seed select control to a second state corresponding to the second seed if the first sequence matches the subsequent output of the de-serializer circuit.

13. The IC device of claim 12, wherein:
the dynamic seed generator is further configured to re-compute the first seed based on the subsequent output of the de-serializer circuit;
the optimized sequence generator is further configured to compute a second digital pseudo-random sequence (second sequence) based on a selectable one of the second seed and the re-computed first seed, based on the seed select control; and
the checker is further configured to compare the second sequence to a current output of the de-serializer circuit.

14. The IC device of claim 13, wherein the control circuitry is further configured to perform one or more quality checks on results from the checker when the seed select control is at the second state, including to:
increment an equal count and maintain the seed select control at the second state if the second sequence matches the current output of the de-serializer circuit and the equal count does not meet an equal count threshold; and
set a lock, increment a sample count and maintain the seed select control at the second state if the second sequence matches the current output of the de-serializer circuit and the equal count meets the equal count threshold.

15. The IC device of claim 14, wherein the control circuitry is further configured to:
increment an error count, increment the sample count, and maintain the seed select control at the second state, if second sequence matches the current output of the de-serializer circuit and the lock is set; and
reset the seed select control to the first state if the second sequence does not match the current output of the de-serializer and the lock is not set.

16. The IC device of claim 11, wherein:
the de-serializer circuit is configured to de-serialize a segment of a digital stream; and
the dynamic seed generator is further configured compute the first seed by arranging the output of the de-serializer based on a bit position of a first bit or a first symbol of the segment of the digital stream.

17. An integrated circuit (IC) device, comprising:
a digital pseudo-random sequence detector circuit configured to convert a de-serialized segment of a digital stream to a first digital pseudo-random sequence seed (first seed), and detect a digital pseudo-random sequence of the digital stream based on the first seed.

18. The IC device of claim 17, wherein the digital pseudo-random sequence detector circuit is further configured to:
convert the de-serialized segment to the first seed by arranging the de-serialized segment of the digital stream based on a bit position of a first bit or a first symbol of the segment of the digital stream.

19. The IC device of claim 17, wherein the digital pseudo-random sequence detector circuit is further configured to:
compute a first digital pseudo-random sequence (first sequence) based on the first seed;
compute a second digital pseudo-random sequence seed (second seed) based on the first sequence; and
compare the first sequence to a subsequent de-serialized segment of the digital stream.

20. The IC device of claim 19, wherein the digital pseudo-random sequence detector circuit is further configured to:
re-compute the first seed based on the subsequent de-serialized segment of the digital stream;
compute a second digital pseudo-random sequence (second sequence) based on the re-computed first seed if the first sequence does not match the subsequent de-serialized segment of the digital stream;
compute the second sequence based on the second seed if the first sequence matches the subsequent de-serialized segment of the digital stream; and
compare the second sequence to a current de-serialized segment of the digital stream.
